(19) United States
(12) Patent Application Publication
(10) Pub. No.: US 2007/0051364 A1
(43) Pub. Date: Mar. 8, 2007

(54) Method For Treating Nasal Irritation

(76) Inventors: Abby Noma Jacobson, Queen Creek, AZ (US); Peter M. Crane, Queen Creek, AZ (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/465,061

(22) Filed: Aug. 16, 2006

Related U.S. Application Data
(63) Continuation-in-part of application No. 10/382,407, filed on Mar. 6, 2003, now abandoned.

(51) Int. Cl. A62B 7/00

(52) U.S. Cl. 128/200.24

(57) ABSTRACT

A method for treating nasal cavity irritation, such as symptoms of allergic rhinitis. The method includes inserting a plug of a frozen liquid into a nasal cavity of a patient experiencing nasal irritation. The method also includes holding the plug against a lining of the nasal cavity to reduce the irritation.

### SPECIFIC DATA RELATED TO THE INVENTION

This application is a continuation-in-part (CIP) of U.S. patent application Ser. No. 10/382,407, filed Mar. 6, 2003.

### FIELD OF THE INVENTION

The present invention relates generally to treatment of nasal irritation, and more particularly, to applying ice to a portion of a lining of a nasal passage for relieving allergic rhinitis symptoms.

### BACKGROUND OF THE INVENTION

Approximately 40 million people in the United States suffer from a condition known as “allergic rhinitis.” According to the Center for Disease Control, 5 million new cases are diagnosed each year. Allergic rhinitis is the most common chronic disease in humans and generally manifests between ages five and thirty years. Furthermore, according to the Center for Disease Control, in the year 2000, 9 million medical doctor visits were attributed to allergic rhinitis at an approximate cost of 500 million dollars for office visits alone.

It has been reported that the occurrence of allergic rhinitis in Great Britain is 23% of the population, and 36% of the population in Japan suffers from this condition. Similar conditions such as hay fever, allergies, nasal and sinus conditions, and colds can all affect the nasal passages.

Anatomically, allergic rhinitis is defined as an inflammation of the mucous membranes that line the nose and nasal passages. It is magnified by a combination of symptoms which include nasal congestion, nasal obstruction, discharge, sneezing, and facial pain and swelling, membrane dryness, and inability to breathe. It can be “seasonal” such as in hay fever or perennial such as in allergic reaction to dust mite feces. It also appears in “episodic” reactions such as in allergies to animal dander.

Current products and treatments that attempt to address these nasal symptoms include allergy shots, injected medications, oral steroids, oral antihistamines, intra-nasal antihistamines, oral decongestants, a wide variety of nasal sprays, nasal strips, and dilating devices. All of these products have drawbacks and shortcomings and are unable to solve the condition for all sufferers. Furthermore, the medications all have published side effects. Allergy shots and injected medications cannot be self-administered and are therefore inconvenient and time consuming, and are not entirely successful in opening swollen nasal cavities. For example, all nasal mucosa dilating sprays include warnings about dosage levels and set limits on periods of use. Furthermore, their overuse may become problematic as a result of a well known rebound effect wherein symptoms may worsen when the efficacy of the spray wear off.

In an attempt to deal with these shortcomings, various devices and methods have been devised, including those described in the following patents: U.S. Pat. No. 4,749,700 to Weenie, issued Jun. 7, 1988, U.S. Pat. No. 4,778,810 to Wenig, et al., issued Oct. 18, 1988, and U.S. Pat. No. 4,729,997 to Wenig, issued Mar. 8, 1988. In addition, nasal saline sprays have been used to moisturize nasal passages and to dissolve build-up of the nasal mucosa. However, saline solutions alone have not proved satisfactory for the relief of nasal congestion.

Nasal dilators for aiding breathing through the nose are known. However, these devices are not generally effective in relieving nasal congestion and blockage, sinus discomfort and pain, and other cold/allergy symptoms. U.S. Pat. No. 4,414,977 issued to Rezakhany discloses one such nasal dilator. This dilator includes top and bottom rings connected by a rear strut and a front strut, and is placed in the nasal passage. Such a nasal dilator suffers from the drawbacks of being uncomfortable to wear, causing irritation and itching of the nostril, being unsafe to use at night during sleep, and being inconvenient to use when the wearer has nasal drainage. Other nasal dilators are disclosed in U.S. Pat. No. 5,533,499, issued to Johnson, U.S. Pat. No. 5,533,503, issued to Doubek, et al., and U.S. Pat. No. 5,546,929, issued to Muchin. These nasal dilators are flexible strips with spring members that adhere to the bridge of the nose and adhere to the exterior surface of the nose. They can be unsightly, do nothing to eliminate swelling, and have no moisturizing features. Furthermore, U.S. Pat. No. 5,890,486, issued to Mitra, et al., April 1999, is another truss style nasal dilator held in place by an adhesive substance, and incorporates a thermal element. This product also fails to address swollen membranes dry mucosa or in the nasal passage.

U.S. Pat. No. 4,369,777, issued to Lwoff, et al., Jan. 25, 1983, describes an invention to deliver a stream of heated, humidified air to the nasal mucosa. This product does address the dry mucous membrane but will intensify the swollen tissues through the application of heat, thereby making breathing more difficult. U.S. Pat. No. 5,693,077, issued to Friedman, Dec. 2, 1997, calls for the application of cold or frozen water or saline in small bags, plastic tubes or metal tubes, applied intra-orally. This invention fails to apply the needed relief to the nasal passages directly and can be uncomfortable when used in metal tubes. U.S. Pat. No. 5,527,351, issued to Friedman, Jun. 18, 1996 describes a similar invention having similar drawbacks as the '077 patent.

As described above, treatment of nasal irritation and swelling, such as may be caused by allergic rhinitis, has historically focused on applying heat and/or humidified air to the nasal mucosa, administering various forms of nasal sprays, and/or applying mechanical nasal dilators to open the nasal passages. However, none of the conventional methods for treating nasal irritation are believed to describe or suggest applying coldness to a portion of the nasal lining. Furthermore, it is believed that such application of coldness to the nasal lining would be counterintuitive due to a discomfort a user may expect to feel as result of inserting an cold object into his or her nostril.

### SUMMARY OF THE INVENTION

The invention includes a method for treating nasal cavity irritation. The method includes inserting a plug of a frozen liquid into a nasal cavity of a patient experiencing nasal irritation. The method also includes holding the plug against a lining of the nasal cavity to reduce the irritation.

### BRIEF DESCRIPTION OF THE DRAWINGS

The features of the invention believed to be novel are specifically set forth in the appended claims. The features and advantages of the present invention will become apparent from the following detailed description of the invention when read with the accompanying drawings in which:

FIG. 1 shows an embodiment of a frozen saline applicator.

FIG. 2 shows an embodiment of the handle of the frozen saline applicator.

FIG. 3 shows the frozen saline applicator in an individual dosage package.

FIG. 4 shows a number of frozen saline applicators, each contained respective individual dosage packages in a dispensing arrangement.

FIG. 5 shows an embodiment of the frozen saline applicator positioned in a human nasal cavity.

FIG. 6 shows another example embodiment of the frozen saline applicator having a stop for limiting a depth of insertion of the application into a human nasal cavity.

FIG. 7 shows the frozen saline applicator of FIG. 6 positioned in a human nasal cavity.

### DETAILED DESCRIPTION OF THE INVENTION

Unlike conventional methods of treating allergic rhinitis, none of which are believed to describe the use of coldness as a treatment, the present invention is directed to a method of treating nasal irritation that includes applying a plug of frozen liquid to a lining of a nasal cavity. Specifically, the method may include inserting a plug of a frozen liquid into a nasal cavity of a patient experiencing nasal irritation and then holding the plug against a lining of the nasal cavity to reduce the irritation.

FIG. 1 shows an example embodiment of a frozen liquid applicator 10 for use in treating nasal irritation according to the above method. The applicator 10 comprises nasal suppository 12 and may include a handle 14. In the context of the invention, the term suppository is intended to mean a dissolvable plug, which may or may not include a medication, for placement in a nasal cavity for a therapeutic purpose. The nasal suppository 12 may be generally shaped as an elongated plug to allow insertion into a nasal cavity against a lining of the nasal cavity for treatment of nasal cavity irritation, such as allergic rhinitis. In particular, the suppository 12 can include a generally elongate, tapering shape 16, having a relatively smaller cross section at a proximal end 18, and a relatively larger cross section at a distal end 20. For example, the suppository 12 may include a frusto-conical shape having a hemispherically shaped 22 proximal end 18 to ease insertion into the nasal cavity and to minimize irritation of sensitive tissues, such as nasal mucosa, and/or turbinates of the nose. In an example embodiment, a diameter 21 of the suppository 12 at the distal end 20 may be limited to be about 1.1 centimeters, and a diameter 19 of the suppository 12 at the proximal end 18 may be limited to be about 0.8 centimeters. In an aspect of the invention, the length 11 of the suppository may be limited to about 2.5 centimeters. It should be understood that such dimensions may need to be modified for use with smaller adults or children. For example, the diameters 19, 21 and length 11 may need to be reduced by about 50% for use with children. In another aspect, the suppository 12 may be conformally shaped to match the interior of a human nasal cavity. For example, the suppository 12 may be adapted for different sizes and shapes to accommodate variability in the size and shape of nasal cavities in humans, such as nasal cavity size variability between infants, children, and adults.

In a further aspect of the invention, the suppository 12 may be formed from a frozen liquid, such as water, or a saline solution in a therapeutic concentration. The suppository 12 may or may not include a medication, such as menthol, a decongestant, an antihistamine, a steroid or other known medications to treat nasal irritations or symptoms of rhinitis or sinusitis. Advantageously, the frozen suppository 12 provides relief from inflamed tissues by reducing nasal swelling through the direct application of coldness to inflamed nasal passages. In addition, the frozen suppository 12 melts gradually after being inserted into an affected nasal cavity, thereby providing moisture to dry tissues, such as the lining of the nasal cavity. Accordingly, the frozen suppository 12 helps relieve the swelling and nasal passage dryness associated with rhinitis, such as allergic rhinitis. It has been experimentally determined that relief from irritation occurs within about one minute of application and that the suppository 12 lasts for about five to about seven minutes before melting away.

FIG. 2 shows an embodiment of the handle 14 of the frozen saline applicator 10. The suppository 12 is mounted on the handle 14 for facilitating grasping of the applicator 10, positioning of the suppository 12 in the nasal cavity, and holding the suppository 12 in place within the nasal cavity. With the handle 14, users may hold the suppository 12 in the nasal cavity and may move it within the nasal cavity, withdraw it, or place it against a sore area. After treatment, remaining portions of the suppository 12 may be re-frozen and re-used.

The handle 14 generally comprises an elongated shaft 24, having a proximal end 26 axially embedded, along an elongate direction of the suppository 12, in a portion of the suppository 12 near the distal end 22. In an example embodiment, the handle extends into the suppository 12 about 50% of the length 11 of the suppository 12. The distal end 28 of the shaft 24 extends from the distal end 22 of the suppository 12 to allow grasping of the handle 10. For example, the distal end 28 of the shaft 24 may protrude from the distal end 22 of the suppository 12 by about 5 centimeters. In an embodiment, the handle 14 may include a head 30 at a proximal end 26 of the shaft 24 for anchoring the handle 14 within the suppository 12. In a further aspect, the head 30 can be is mushroom-shaped, with the convex face 31 of the mushroom-shaped head 30 oriented towards the proximal end 18 of the suppository 12 to provide anchoring of suppository 12. In another embodiment, the handle 14 includes a grip 32 at a distal end 28 to provide a graspable surface for holding and positioning the applicator 10. For example, the grip 32 may include a disk mounted, or formed, on the shaft 24, which can be grasped between a thumb and forefinger, for example, for handling the applicator. In another aspect, the disk may include a gripping surface, such as checkering, on one or both sides of the disk.

Turning now to the dispensing aspects of the invention, FIG. 3 shows the frozen saline applicator 10 in an individual dosage package 32. Generally, the individual dosage package 32 includes a leak resistant molding package 34 comprising an elongate chamber 36 for accepting a nasal passage therapeutic liquid, such as a saline solution. In an aspect of the invention, the chamber 36 has a shape to conform to the interior of a nasal passage, so that when a liquid is injected into the chamber 36 and subsequently frozen, the frozen liquid assumes the shape of the chamber 36 and, correspondingly conforms to the interior of a nasal passage. For example, the chamber 36 may have a generally tapering shape, as described previously regarding the suppository 12. In other aspects, the proximal end 36 of the chamber is hemispherical, and the chamber 36 may be conformally shaped to match the interior of a human nasal cavity. In addition, the chamber 36 may be adapted to different sizes and shapes to accommodate variability in the size and shape of nasal cavities in humans, such as nasal cavity size variability between infants, children, and adults.

The handle 14 for a suppository 12 to be formed in the chamber 36, extends axially along an elongate direction of the chamber 36, into a portion of the chamber 36 and protrudes from an end of the molding package 34. A liquid, such as a therapeutic saline solution, is introduced into the chamber 36 so that the chamber 36 is substantially filled. Accordingly, when frozen, the fluid forms a suppository 12 around the handle 14 corresponding to the shape of the chamber 36. Therefore, the shape of the chamber 36 determines the shape of the frozen suppository 12. In aspect of the invention, the package 34 is separable so that a frozen suppository 12 may be extracted from the package 34 for application in an affected nasal cavity. For example, a pull away tab 42 may be provided so that the package may be peeled into two halves to release the suppository 12.

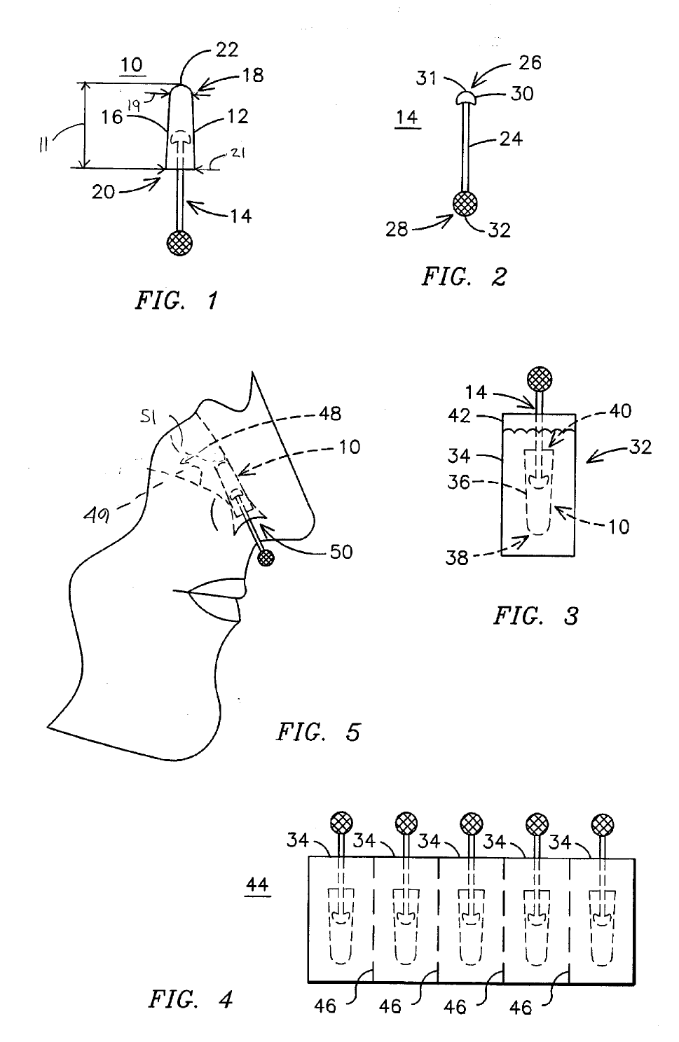

FIG. 4 shows a number of frozen saline applicators 10, each contained in respective individual dosage packages 34 in a dispensing arrangement 44. In an aspect of the invention, the individual packages 34 may be removably attached to one another for ease in dispensing. For example, the individual packages 34 may by attached along elongate sides, and perforations 46 may be provided to allow individual packages 34 to be easily removed from an attachment to another package 34. Accordingly, a convenient means for dispensing the saline applicators 10 is provided. In an aspect of the invention, the dispensing arrangement 44 can be purchased and stored at room temperature if desired, so that the saline solution in the chamber 36 remains in a liquid form. When use of the saline applicator 10 is indicated, one or more of the packages 34 can be placed in a freezer, for example, to freeze the liquid saline solution in the chamber 36. Once the saline solution is frozen, an individual package 34 can be separated from the dispensing arrangement 44 and the frozen saline applicator 10 can be removed from the package 34. The released frozen saline applicator 10 can then be inserted into an affected nasal cavity for relief from nasal cavity irritation, such as inflammation and dryness associated from allergic sinusitis.

FIG. 5 shows the frozen saline applicator 10 positioned in a human nasal cavity 48 against a lining 49 of the cavity 48. The handle 14 may be grasped by the user and used to gently insert the suppository 12, proximal end 18 first, through the nostril 50 and into the affected nasal cavity 48, and held in place against a portion of the lining 49 by the user to relieve nasal irritation. Advantageously, the frozen suppository 12 helps to shrink swollen nasal cavity membranes and, as the suppository 12 melts, provides moisture to ease dryness of the nasal cavity. The suppository 12 may be repositioned in the nasal cavity as required to treat different regions of the nasal cavity. In an aspect of the invention, the suppository 12 may be inserted into the nasal cavity so that a proximal end 18 is coterminous with a middle turbinate 51 of the nasal cavity 48.

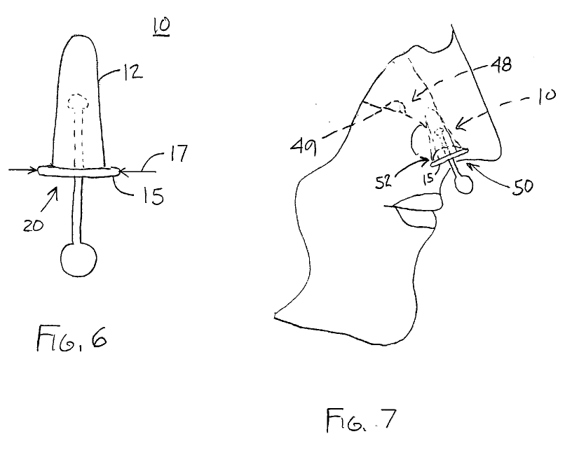

FIG. 6 shows another example embodiment of the frozen saline applicator that includes a stop 15 for limiting a depth of insertion of the suppository 12 into a human nasal cavity. The stop 15 may be configured to extend perpendicularly from the handle 14. In an example embodiment, the stop 15 may comprise a round disk attached to, or integrally formed with, the handle 14. The disk 15 may have a diameter 17 sufficiently large to limit an insertion depth of the suppository 12 by lodging against an opening portion 52 of the nostril 50 as shown in FIG. 7 to prevent insertion of the suppository 12 further into the nostril, for example, to avoid damage to turbinates of the nose. In an example embodiment, the disk 15 may have a diameter of about 1.5 centimeters. The disk 15 may be disposed on the handle about 2.5 centimeters from the distal end 22 of the suppository 12 so that the disk 15 limits the insertion depth to about 2.5 centimeters. The above dimensions may be reduced by about 50% for use by children. In an example embodiment, the disk 15 may be spaced away from a proximal end 22 of the suppository 12.

While only certain preferred features of the invention have been shown by way of illustration, many modifications and changes will occur to those skilled in the art. It is, therefore, to be understood that the present claims are intended to cover all such modifications and changes, which fall within the true spirit of the invention.

What is claimed is:

1. A method for treating nasal irritation comprising:
inserting a plug of a frozen liquid into a nasal cavity of a patient experiencing nasal irritation; and
holding the plug against a lining of the nasal cavity to reduce the irritation.

2. The method of claim 1, further comprising configuring the plug to fit within at least a portion of a human nasal cavity.

3. The method of claim 2, further comprising forming the plug to have a frusto-conical shape.

4. The method of claim 3, further comprising limiting an axial length of the plug to about 2.5 centimeters.

5. The method of claim 3, further comprising limiting a diameter of the plug at a distal end to about 1.1 centimeters.

6. The method of claim 3, further comprising limiting a diameter of the plug at a proximal end to about 0.8 centimeters.

7. The method of claim 1, further comprising providing a handle extending from the plug for allowing a user to hold the plug in place within the nasal cavity.

8. The method of claim 7, further comprising providing a stop associated with the handle for limiting an insertion depth of the plug within the nasal cavity by lodging against an opening portion of a nostril.

9. The method of claim 8, further comprising disposing the stop at location on the handle for limiting the insertion depth of the plug to about 2.5 centimeters.

10. The method of claim 8, further comprising configuring the stop to have a disk shape.

11. The method of claim 10, further comprising sizing the disk to have a diameter of about 1.5 centimeters.

12. The method of claim 10, further comprising inserting the plug to so that a proximal end of the plug is coterminous with a middle turbinate of the nasal cavity.

13. The method of claim 1, wherein the frozen liquid comprises saline solution having a therapeutic concentration.

14. The method of claim 18, wherein the frozen liquid comprises a medication for the treatment of symptoms associated with rhinitis.
